(19) United States
(12) Patent Application Publication
(10) Pub. No.: US 2015/0134525 A1
(43) Pub. Date: May 14, 2015

(54) Method for Preventing Misappropriation of Plastic Money and Plastic Money

(71) Applicant: National Tsing Hua University, Hsin Chu City (TW)

(72) Inventors: Wei-Chang Yeh, Hsinchu City (TW); Wei-Hung Yeh, Hsinchu City (TW)

(73) Assignee: National Tsing Hua University, Hsin Chu City (TW)

(21) Appl. No.: 14/158,781

(22) Filed: Jan. 18, 2014

(30) Foreign Application Priority Data
Nov. 14, 2013 (TW) 102141526

(51) Int. Cl. G06Q 20/40

(52) U.S. Cl. CPC G06Q 20/409
USPC 705/44

(57) ABSTRACT

A method for preventing misappropriation of plastic money includes transmitting a first verification data from plastic money to an accompanied card through a wireless signal; comparing the first verification data with a second verification data stored in the accompanied card; if the comparison result is that the first verification data is identical to the second verification data, transmitting a verification success message from the accompanied card to the plastic money through the wireless signal; transmitting a first short message or E-mail including intended payment information from the plastic money to a cell phone number or an E-mail address of a cardholder of the plastic money through the wireless signal to inquire whether the cardholder of the plastic money agrees to pay or not; clicking a particular hyperlink in the first E-mail with a mobile device or pressing a particular button or icon of the mobile device by the cardholder of the plastic money to agree to pay and transmitting an approved payment message back to the plastic money through the wireless signal.

### CROSS-REFERENCE TO RELATED APPLICATION

The present application claims priority to the TAIWAN Patent Application Serial Number 102141526 of Nov. 14, 2013, which is herein incorporated by reference in its entirety.

### TECHNICAL FIELD

The present invention generally relates to plastic money, and more particularly to a method for preventing misappropriation of plastic money and a plastic money.

### BACKGROUND OF THE RELATED ART

Current plastic money, for example credit card, debit card, stored-value card, and so on, is commonly used. People usually carry more than one types of plastic money, such as credit card, debit card, stored-value card, etc to pay conveniently and prevent carrying too much cash, so as to enhance safety. However, card issuers haven't designed the measures to prevent the misappropriation of plastic money, resulting in that it is very easy to misappropriate the plastic money, for instance credit card, debit card, stored-value card, and so on, and thus the cardholders suffer huge damage if his plastic money is misappropriated. For example, if a large payment by credit card is encountered, although the card issuers contact the cardholder or send a short message to inform the cardholder after the large payment by credit card is finished, it is too late if the credit card is misappropriated. Therefore, the misappropriation of the credit card cannot be stopped in time, and the short message cannot be sent simultaneously to inform the cardholder as the payment by credit card is being executed. Moreover, the stored-value card, for instance Easy Card, iCash or I Pass Card, and so on, does not need the cardholder's signature when used. Thus, if the stored-value card is lost and is picked up by others, the person who picks up the stored-value card can easily utilize the remaining stored value in the stored-value card to pay. Furthermore, debit card or credit card only needs the cardholder's signature when used. If the person who picks up the debit card or the credit card can imitate the cardholder's signature on the card to pay, the misappropriation of the debit card or the credit card cannot be prohibited. Further, there are some contactless credit cards which can be sensed directly when the payment is not large and need no signature, thereby the misappropriation of the contactless credit card is even more easy.

Accordingly, there is still a need for a technical solution which can prevent the misappropriation of the plastic money.

### SUMMARY

In one aspect, the present invention discloses a method for preventing misappropriation of plastic money, comprising: transmitting a first verification data from a plastic money to an accompanied card through a wireless signal; comparing the first verification data with a second verification data stored in the accompanied card; if the first verification data is identical to the second verification data, transmitting a verification success message from the accompanied card to the plastic money through the wireless signal; transmitting a first short message or E-mail including intended payment information from the plastic money to a cell phone number or an E-mail address of a cardholder of the plastic money through the wireless signal to inquire whether the cardholder of the plastic money agrees to pay or not; clicking a particular hyperlink in the first E-mail with a mobile device or pressing a particular button or icon of the mobile device by the cardholder of the plastic money to agree to pay and transmitting an approved payment message back to the plastic money through the wireless signal; and continuing and completing payment procedure by the plastic money.

In another aspect, the present invention discloses a plastic money comprising an information storage medium containing program instructions, which when executed by a microprocessor of the plastic money, cause the microprocessor to perform the following: transmitting a first verification data from a plastic money to an accompanied card through a wireless signal; comparing the first verification data with a second verification data stored in the accompanied card; if the first verification data is identical to the second verification data, transmitting a verification success message from the accompanied card to the plastic money through the wireless signal; transmitting a first short message or E-mail including intended payment information from the plastic money to a cell phone number or an E-mail address of a cardholder of the plastic money through the wireless signal to inquire whether the cardholder of the plastic money agrees to pay or not; clicking a particular hyperlink in the first E-mail with a mobile device or pressing a particular button or icon of the mobile device by the cardholder of the plastic money to agree to pay and transmitting an approved payment message back to the plastic money through the wireless signal; and continuing and completing payment procedure by the plastic money.

In still another aspect, the present invention discloses a plastic money, comprising: a microprocessor; a wireless chip coupled to the microprocessor to search and connect available wireless signals, transmit verification data to an accompanied card through the wireless signals or transmit short messages or E-mails to a cell phone number or an E-mail address of a cardholder of the plastic money through the wireless signals; a paper battery coupled to the microprocessor to provide power to the wireless chip; and an inductive charging module coupled to the microprocessor to charge the paper battery wirelessly and inductively.

One advantage of the present invention is that the agreement of the cardholder of the plastic money can be obtained before actually performing the payment procedure, so as to prevent misappropriation of the plastic money.

Another advantage of the present invention is that the plastic money can be verified with the accompanied card which the cardholder of the plastic money carries about before actually performing the payment procedure, so as to prevent misappropriation of the plastic money

These and other advantages will become apparent from the following description of preferred embodiments taken together with the accompanying drawings and the appended claims.

### BRIEF DESCRIPTION OF THE DRAWINGS

The present invention may be understood by some preferred embodiments and detailed descriptions in the specification and the attached drawings below.

FIG. 1 illustrates a flow diagram of a method for preventing misappropriation of plastic money in accordance with one embodiment of the present invention;

FIG. 2 illustrates a flow diagram of a method for preventing misappropriation of plastic money in accordance with one embodiment of the present invention;

FIG. 3 illustrates a block diagram of a plastic money in accordance with one embodiment of the present invention; and

FIG. 4 illustrates a block diagram of an accompanied card in accordance with one embodiment of the present invention.

### DETAILED DESCRIPTION

The present invention will now be described with the preferred embodiments and aspects and these descriptions interpret structure and procedures of the present invention only for illustrating but not for limiting the Claims of the present invention. Therefore, except the preferred embodiments in the specification, the present invention may also be widely used in other embodiments.

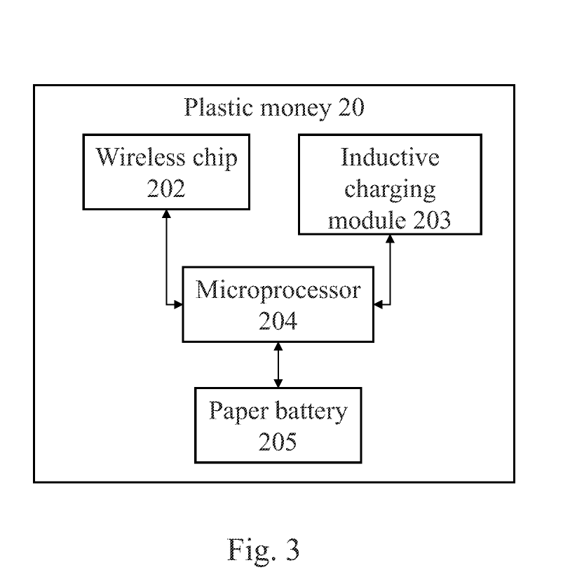

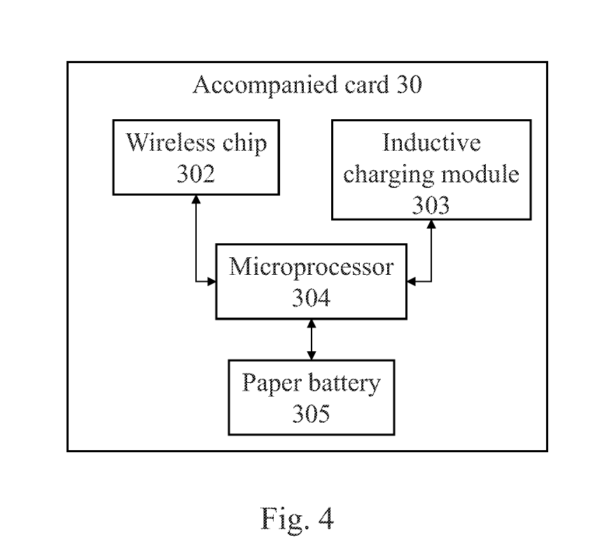

The present invention discloses a method for preventing misappropriation of plastic money and a plastic money. As shown in FIGS. 3 and 4, the method for preventing misappropriation of plastic money mainly employs a plastic money (or plastic card) 20, for instance credit card, debit card, stored-value card such as Easy Card, iCash, I Pass Card and so forth, which includes a wireless chip 202, and an accompanied card 30 which includes a wireless chip 302. The accompanied card 30 described herein is another small card or chip which the cardholder of the plastic money carries about, and can be attached to the key ring. The wireless chip 302 of the accompanied card 30 stores verification data related to the plastic money 20, such as name, identification number (such as identity card number, passport number, etc), birthday, cell phone number, E-mail address, address and so forth of the cardholder of the plastic money, so as to compare with the data transmitted by the plastic money 20 when a payment by the plastic money 20 is to be performed such as via swiping the card or sensing the card.

The wireless chip 202 of the plastic money 20 also stores verification data, for example name, identification number (such as identity card number, passport number, etc), birthday, cell phone number, E-mail address, address and so forth of the cardholder of the plastic money, such that the verification data can be transmitted to the accompanied card 30 via wireless signal(s) by utilizing the wireless chip 202 to compare with the verification data stored in the accompanied card 30 when a payment by the plastic money 20 is to be performed such as via swiping the card or sensing the card. Furthermore, a card number of the plastic money is also stored in the wireless chip 202 of the plastic money 20. In one embodiment, as shown in FIGS. 3 and 4, the plastic money 20 and/or the accompanied card 30 may optionally include a paper battery 205 and 305 to provide power to the wireless chip 202 and 302 in the plastic money 20 and/or the accompanied card 30. In one embodiment, as shown in FIGS. 3 and 4, the plastic money 20 and/or the accompanied card 30 may optionally include an inductive charging module 203 and 303 to charge the paper battery 205 and 305 wirelessly and inductively. The wireless chip 202 and 203 in the plastic money 20 and/or the accompanied card 30 can automatically search and connect available wireless signal(s) so as to transmit or receive verification data and various kinds of messages or signals. In one embodiment, a wireless charger may be disposed on a credit card machine or a cashier machine, such that the inductive charging module 203 and 303 of the plastic money 20 and/or the accompanied card 30 may perform wireless inductive charging via the wireless charger. Besides those disclosed above, the plastic money 20 of the present invention may include some known circuits for plastic money and/or other known elements. The detailed descriptions of the known circuits for plastic money and/or other known elements are omitted herein so as to not obscure the description of the present invention.

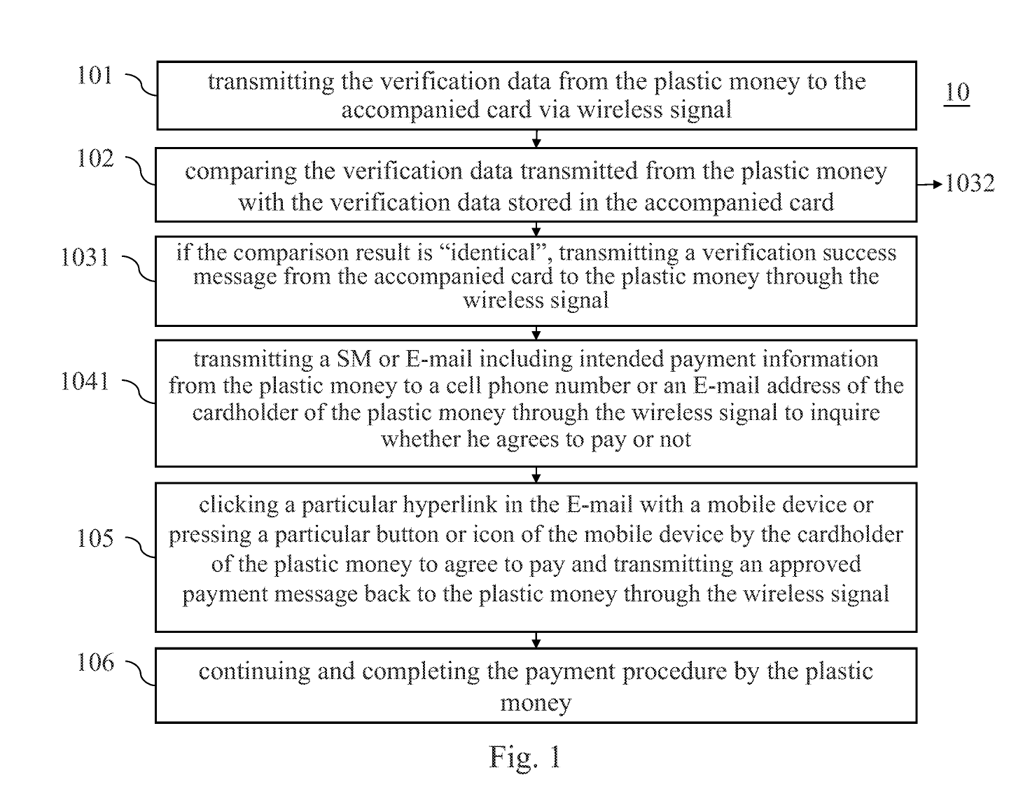

As shown in FIG. 1, in one embodiment of the present invention, the method for preventing misappropriation of plastic money 10 may include a step 101, in which when a payment by the plastic money is to be performed such as via swiping the card or sensing the card, the verification data is transmitted from the plastic money to the accompanied card via wireless signal(s). The verification data may be two or more of name, identification number (such as identity card number, passport number, etc), birthday, cell phone number, E-mail address and address of the cardholder of the plastic money. Subsequently, the verification data transmitted from the plastic money is compared with the verification data stored in the wireless chip of the accompanied card in step 102. Then, if the comparison result is that the verification data transmitted from the plastic money is identical to the verification data stored in the wireless chip of the accompanied card, a verification success message is transmitted from the accompanied card to the plastic money through the wireless signal(s) in step 1031. Subsequently, after the plastic money receives the verification success message, a short message (SM) or E-mail including intended payment information, for instance intended credit card payment information, is transmitted from the plastic money to a cell phone number or an E-mail address of the cardholder of the plastic money through the wireless signal(s) in step 1041. The intended payment information may include for example intended payment amount, partial card number of the plastic money, name of the cardholder of the plastic money, intended payment date, intended time of payment and so on, and the short message or E-mail may further include messages to inquire whether the cardholder of the plastic money agrees to pay or not, besides the intended payment information.

Then, if the cardholder of the plastic money agrees to pay, the cardholder of the plastic money can employ a mobile device, such as a cell phone, a smart phone, a notebook, a tablet PC, etc to click a particular hyperlink in the E-mail or press a particular button or icon, for example a “OK” button or icon, of the mobile device to agree to pay, and an approved payment message is transmitted back to the plastic money through the wireless signal(s) in step 105. Subsequently, after the plastic money receives the approved payment message, the plastic money will continue and complete the payment procedure in step 106.

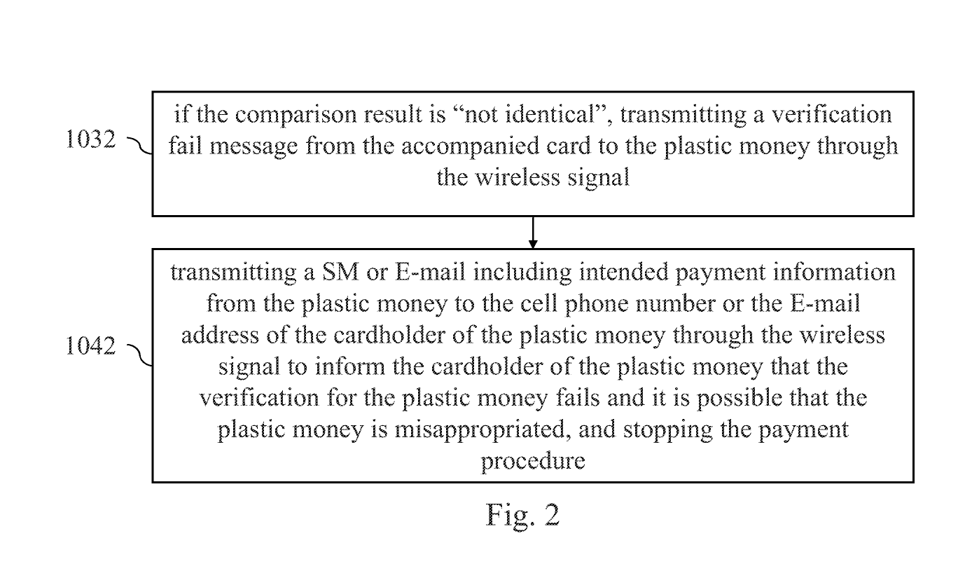

As shown in FIG. 2, if the comparison result is that the verification data transmitted from the plastic money is not identical to the verification data stored in the wireless chip of the accompanied card, a verification fail message is transmitted from the accompanied card to the plastic money through the wireless signal(s) in step 1032. Then, after the plastic money receives the verification fail message, a short message (SM) or E-mail including intended payment information, for instance intended credit card payment information, is transmitted from the plastic money to the cell phone number or the E-mail address of the cardholder of the plastic money through the wireless signal(s), and the payment procedure is stopped in step 1042. The intended payment information may include for example intended payment amount, partial card number of the plastic money, name of the cardholder of the plastic money, intended payment date, intended time of payment and so on, and the short message or E-mail may further include messages to inform the cardholder of the plastic money that the verification for the plastic money fails and it is possible that the plastic money is misappropriated, besides the intended payment information.

As shown in FIGS. 3 and 4, in one embodiment of the present invention, the plastic money 20 and/or the accompanied card 30 may respectively include a microprocessor 204 and 304, which are coupled to the wireless chip 202 and 302, the inductive charging module 203 and 303, and the paper battery 205 and 305 respectively. In one embodiment of the present invention, the information storage medium in the plastic money 20 and/or the accompanied card 30, such as the wireless chip 202 and 302, may contain program instructions. When the program instructions are executed by the microprocessor 204 and 304, the program instructions will cause the microprocessor 204 and 304 to perform the steps of the method disclosed above.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof.

What is claimed is:

1. A method for preventing misappropriation of plastic money, comprising:
transmitting a first verification data from a plastic money to an accompanied card through a wireless signal;
comparing said first verification data with a second verification data stored in said accompanied card;
if said first verification data is identical to said second verification data, transmitting a verification success message from said accompanied card to said plastic money through said wireless signal;
transmitting a first short message or E-mail including intended payment information from said plastic money to a cell phone number or an E-mail address of a cardholder of said plastic money through said wireless signal to inquire whether said cardholder of said plastic money agrees to pay or not;
clicking a particular hyperlink in said first E-mail with a mobile device or pressing a particular button or icon of said mobile device by said cardholder of said plastic money to agree to pay and transmitting an approved payment message back to said plastic money through said wireless signal; and
continuing and completing payment procedure by said plastic money.

2. The method of claim 1, further comprising:
if said first verification data is not identical to said second verification data, transmitting a verification fail message from said accompanied card to said plastic money through said wireless signal; and
transmitting a second short message or E-mail including said intended payment information from said plastic money to said cell phone number or said E-mail address of said cardholder of said plastic money through said wireless signal to inform said cardholder of said plastic money that verification for said plastic money fails and said plastic money is misappropriated, and stopping payment procedure.

3. The method of claim 1, wherein said first short message or E-mail further comprises messages to inquire whether said cardholder of said plastic money agrees to pay or not.

4. The method of claim 1, wherein said second short message or E-mail further comprises messages to inform said cardholder of said plastic money that verification for said plastic money fails and said plastic money is misappropriated.

5. The method of claim 1, wherein said first verification data and said second verification data comprise two or more of name, identification number, birthday, said cell phone number, said E-mail address and address of said cardholder of said plastic money.

6. A plastic money comprising an information storage medium containing program instructions, which when executed by a microprocessor of said plastic money, cause said microprocessor to perform the following:
transmitting a first verification data from a plastic money to an accompanied card through a wireless signal;
comparing said first verification data with a second verification data stored in said accompanied card;
if said first verification data is identical to said second verification data, transmitting a verification success message from said accompanied card to said plastic money through said wireless signal;
transmitting a first short message or E-mail including intended payment information from said plastic money to a cell phone number or an E-mail address of a cardholder of said plastic money through said wireless signal to inquire whether said cardholder of said plastic money agrees to pay or not;
clicking a particular hyperlink in said first E-mail with a mobile device or pressing a particular button or icon of said mobile device by said cardholder of said plastic money to agree to pay and transmitting an approved payment message back to said plastic money through said wireless signal; and
continuing and completing payment procedure by said plastic money.

7. The plastic money of claim 6, further comprising program instructions, which when executed by said microprocessor of said plastic money, cause said microprocessor to perform the following:
if said first verification data is not identical to said second verification data, transmitting a verification fail message from said accompanied card to said plastic money through said wireless signal; and
transmitting a second short message or E-mail including said intended payment information from said plastic money to said cell phone number or said E-mail address of said cardholder of said plastic money through said wireless signal to inform said cardholder of said plastic money that verification for said plastic money fails and said plastic money is misappropriated, and stopping payment procedure.

8. The plastic money of claim 6, wherein said information storage medium comprises a wireless chip.

9. The plastic money of claim 6, wherein said first short message or E-mail further comprises messages to inquire whether said cardholder of said plastic money agrees to pay or not.

10. The plastic money of claim 6, wherein said second short message or E-mail further comprises messages to inform said cardholder of said plastic money that verification for said plastic money fails and said plastic money is misappropriated.

11. The plastic money of claim 6, wherein said first verification data and said second verification data comprise two or more of name, identification number, birthday, said cell phone number, said E-mail address and address of said cardholder of said plastic money.

12. A plastic money, comprising:
a microprocessor;
a wireless chip coupled to said microprocessor to search and connect available wireless signals, transmit verification data to an accompanied card through said wireless signals or transmit short messages or E-mails to a cell phone number or an E-mail address of a cardholder of said plastic money through said wireless signals;
a paper battery coupled to said microprocessor to provide power to said wireless chip; and
an inductive charging module coupled to said microprocessor to charge said paper battery wirelessly and inductively.
